(19) United States
(12) Patent Application Publication
(10) Pub. No.: US 2023/0147398 A1
(43) Pub. Date: May 11, 2023

(54) SPAN LOSS PREDICTION WITH FEDERATED LEARNING

(71) Applicant: FUJITSU LIMITED, Kawasaki-shi (JP)

(72) Inventors: Qiong ZHANG, Plano, TX (US); Naga Raghavendra Anudeep TUNGALA, Garland, CT (US); Calvin WAN, Plano, TX (US); David DAL FARRA, Richardson, TX (US); Paparao PALACHARLA, Richardson, TX (US)

(73) Assignee: FUJITSU LIMITED, Kawasaki-shi (JP)

(21) Appl. No.: 17/520,463

(22) Filed: Nov. 5, 2021

(51) Int. Cl. G06N 20/20

(52) U.S. Cl. CPC G06N 20/20

(57) ABSTRACT

A method may include sending a first machine learning model to one or more optical systems in which the first machine learning model is configured to predict span losses in the optical systems. Each respective optical system may be configured to identify the span losses associated with the respective optical system and locally train the first machine learning model according to the respective identified span losses to obtain a respective local first machine learning model that includes one or more respective local model parameters. The method may include obtaining the respective local model parameters from each respective optical system without obtaining the corresponding respective locally trained first machine learning model. The method may also include generating a second machine learning model based on the obtained local model parameters. The second machine learning model may be used to predict occurrences of span losses corresponding to a given optical system.

The present disclosure generally relates to a system and method of span loss prediction with federated learning.

### BACKGROUND

An optical system may include multiple optical fiber cables configured to transmit light signals from a first location to a second location. Span analysis may be performed to determine whether implementation of one or more given optical fiber cables from the first location to the second location is feasible. Span analysis may include assessment of one or more operating characteristics of the given optical fiber cables, such as attenuation of light between the first location and the second location.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include sending a first machine learning model to one or more optical systems in which the first machine learning model is configured to predict span losses in the optical systems. Each respective optical system may be configured to identify the span losses associated with the respective optical system and locally train the first machine learning model according to the respective identified span losses to obtain a respective local first machine learning model that includes one or more respective local model parameters. The method may include obtaining the respective local model parameters from each respective optical system without obtaining the corresponding respective locally trained first machine learning model. The method may also include generating a second machine learning model based on the obtained local model parameters. The second machine learning model may be used to predict occurrences of span losses corresponding to a given optical system

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is a diagram representing an example system of span loss prediction facilitated by federated learning according to at least one embodiment of the present disclosure;

FIG. 2 is a diagram illustrating example operations related to federated learning and training of a machine learning model configured to predict span losses according to at least one embodiment of the present disclosure;

FIG. 3A illustrates examples of abnormal span loss patterns caused by fiber pinches and bends that may be predicted by the machine learning model trained according to the present disclosure;

FIG. 3B illustrates an example of an abnormal span loss pattern caused by optic fiber deterioration that may be predicted by the machine learning model trained according to the present disclosure;

FIG. 4 is a flowchart of an example method of training a machine learning model via federated learning to predict span losses according to at least one embodiment of the present disclosure; and

FIG. 5 is an example computing system.

### DETAILED DESCRIPTION

An optical system may include multiple optical fiber cables configured to transmit light signals from a first location to a second location to facilitate fiber-optic communications between the first location and the second location. Some amount of energy may be dissipated during propagation of the light signals through the optical fiber cables towards the second location. Consequently, a signal strength (“power”) received at the second location may be attenuated relative to the power injected at the first location of the optical fiber cables.

The difference in power between the first location and the second location may be represented by a span loss of the optical system. Determining the span loss of the optical system may facilitate and/or improve operation of the optical system by clarifying the amount of input power used to generate particular output power levels. Measuring and/or calculating span loss may depend on properties of the optical system, such as a length of the optical fiber cables, configuration of the optical fiber cables, cable management, and/or condition of the optical fiber cables. As such, a first span loss corresponding to a first optical system may be different than a second span loss corresponding to a second optical system. Additionally or alternatively, a first span loss corresponding to a first section of a given optical system may be different than a second span loss corresponding to a second section of the same given optical system.

Consequently, span loss prediction may be challenging because the occurrence of span losses may depend on numerous properties of the optical system. Machine learning models may be used to facilitate prediction of span losses. However, existing machine learning models may not be capable of predicting span losses that occur infrequently (“abnormal span losses”). Because span loss is normally measured with respect to a sequence of data points over a given time period for a given optical fiber, the data used to train the machine learning model may not be provided with information relating to infrequently occurring events, such as abnormal span losses. As such, the machine learning model may not learn to accurately predict the occurrence of abnormal span losses.

The present disclosure relates to, among other things, a system and method of training a machine learning model with federated learning to perform span loss prediction. In some embodiments, federated learning may allow training of the machine learning model using data points corresponding to multiple different optical fibers. As such, a machine learning model trained according to at least one embodiment of the present disclosure may improve the accuracy of span loss predictions. Additionally or alternatively, the machine learning model trained according to the present disclosure may facilitate prediction of abnormal span losses and/or earlier prediction of span losses.

Embodiments of the present disclosure are explained with reference to the accompanying figures.

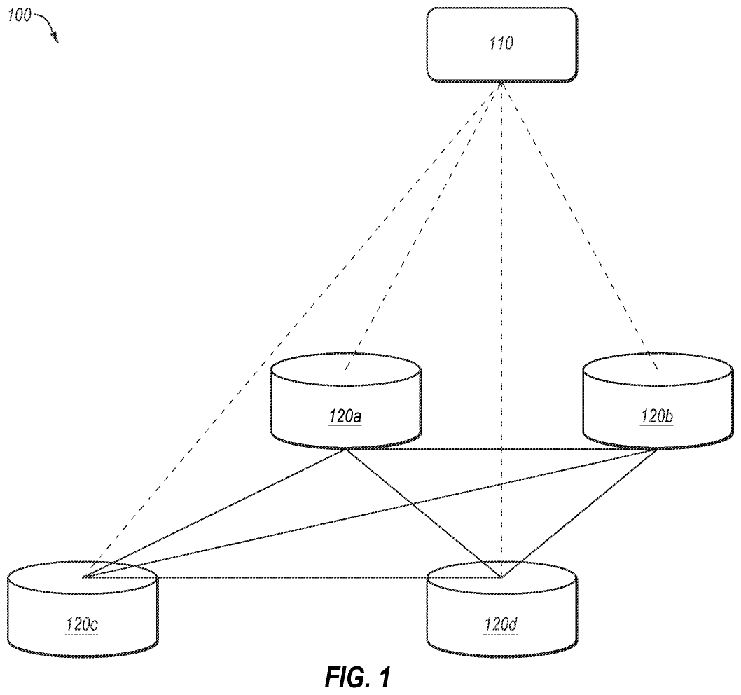

FIG. 1 is a diagram representing an example system 100 of span loss prediction facilitated by federated learning, according to at least one embodiment of the present disclosure. The system 100 may include multiple client optical systems 120a-d (“client optical systems 120”) and a network controller 110.

Each of the client optical systems 120 may be configured to transmit, propagate, and/or receive pulses of light and/or other electromagnetic waves to facilitate fiber-optic communication between various entities included in each of the client optical systems 120. In some embodiments, the client optical systems 120 may include optical add-drop multiplexer systems (OADMs), reconfigurable add-drop multiplexer systems (ROADMs), any other wavelength division multiplexing (WDM) networking systems, and/or any other types of optical systems. Additionally or alternatively, each of the client optical systems 120 may be configured to facilitate fiber-optic communication with other client optical systems 120. The client optical systems 120 may be communicatively coupled to the network controller 110 such that the client optical systems 120 and the network controller 110 may receive and/or transmit information (e.g., model parameters) relating to a machine learning model for detecting span loss in a given client optical system 120.

In some embodiments, the span loss of a given client optical system 120 may be locally measured by the given client optical system 120 in terms of the intensity of the span loss and represented as a sequence of data points as a function of time. The optical behavior of the given client optical system 120 may be sampled at periodic intervals (e.g., every half-second, every second, every five seconds, etc.) to determine the span loss over that period of time.

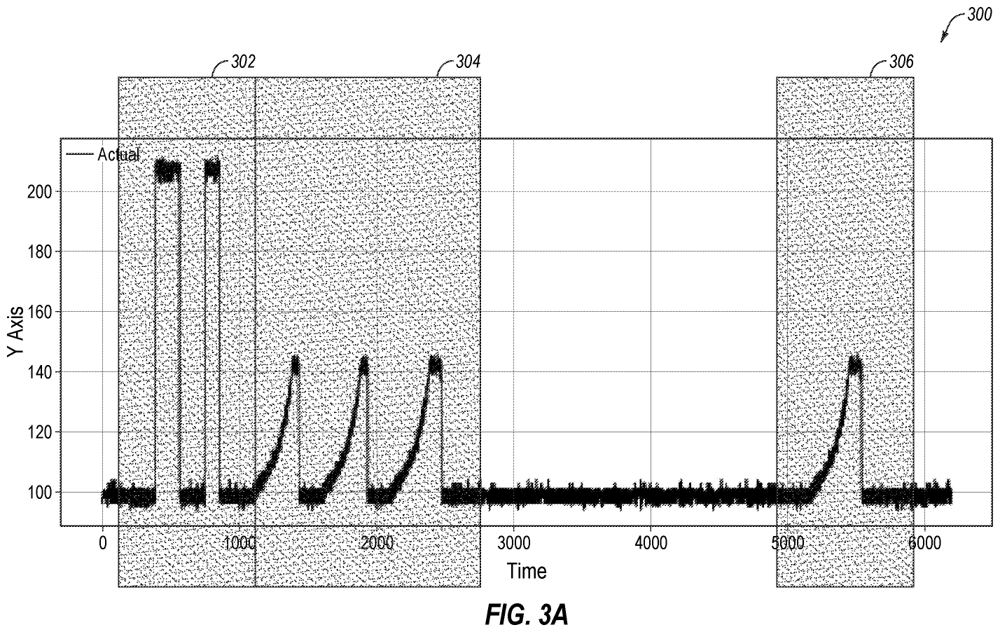

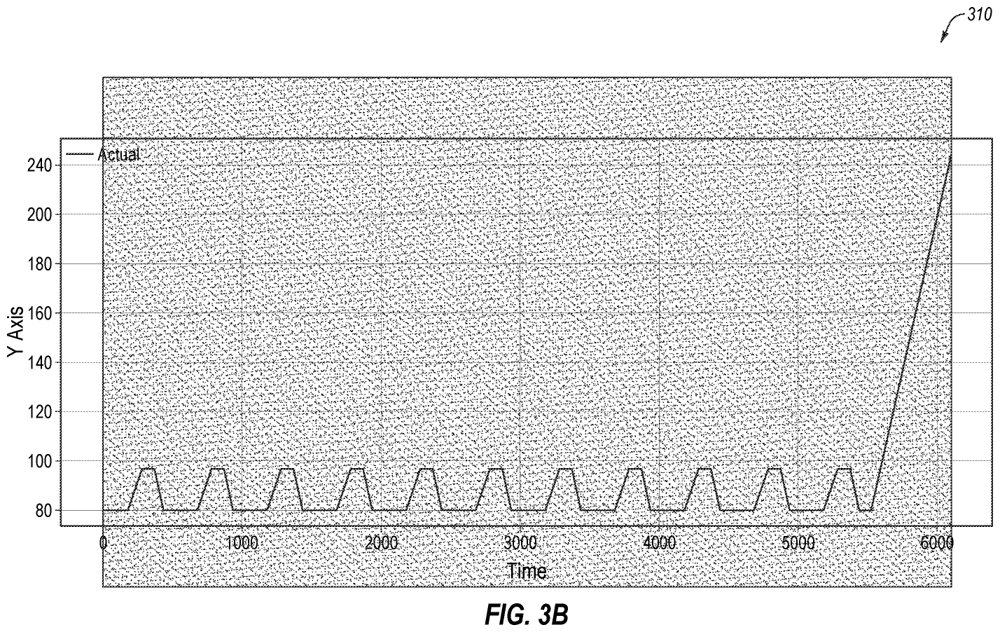

For example, FIGS. 3A and 3B illustrate various patterns of optical behavior that may be measured by the client optical systems 120 and/or predicted by a machine learning model managed by the network controller 110. In some embodiments, a graph 300 may include measurements of span losses of a given span of fiber in terms of decibels (dB) of a given optical system as a function of time in which specific measurement patterns represent span losses experienced by the given optical system 120. For example, as illustrated in FIG. 3A, a first pattern 302 of span loss may represent optical fiber pinches in the given optical system, a second pattern 304 may represent bends in the optical fibers, and a third pattern 306 may represent a bend in the optical fibers. In some embodiments, the patterns of span loss may be identified by one or more operators of the optical systems, pattern-recognition software, previous machine learning and/or federated learning models, and/or any other span loss detection and/or prediction methods.

Additionally or alternatively, as illustrated in FIG. 3B, a pattern of abnormal span loss 310 related to degradation of the optical fibers and/or general hardware over a given period of time may be detected. In some situations, the cause of the span loss associated with the pattern 310 may not be readily identified because the pattern of span loss 310 depicted in FIG. 3B may or may not be correlated with any particular physical phenomenon.

Returning to the description of FIG. 1, each of the client optical systems 120 may be configured to operate independently of one another. In some circumstances, however, two or more of the client optical systems 120 may communicate with each other and/or transmit optical signals to one another. Operators of each of the client optical systems 120 may analyze and/or respond to span losses measured locally at each respective client optical system 120. In these and other embodiments, one or more of the client optical systems 120 may be communicatively coupled to the network controller 110 such that the network controller 110 may operate as a central point of contact between two or more of the client optical systems 120. In other words, the network controller 110 may be configured to send information to and/or receive information from the client optical systems 120. Thus, the network controller 110 be configured to manage span loss data analysis for multiple client optical systems 120, such as via training a machine learning model configured to detect and identify the occurrences of span losses.

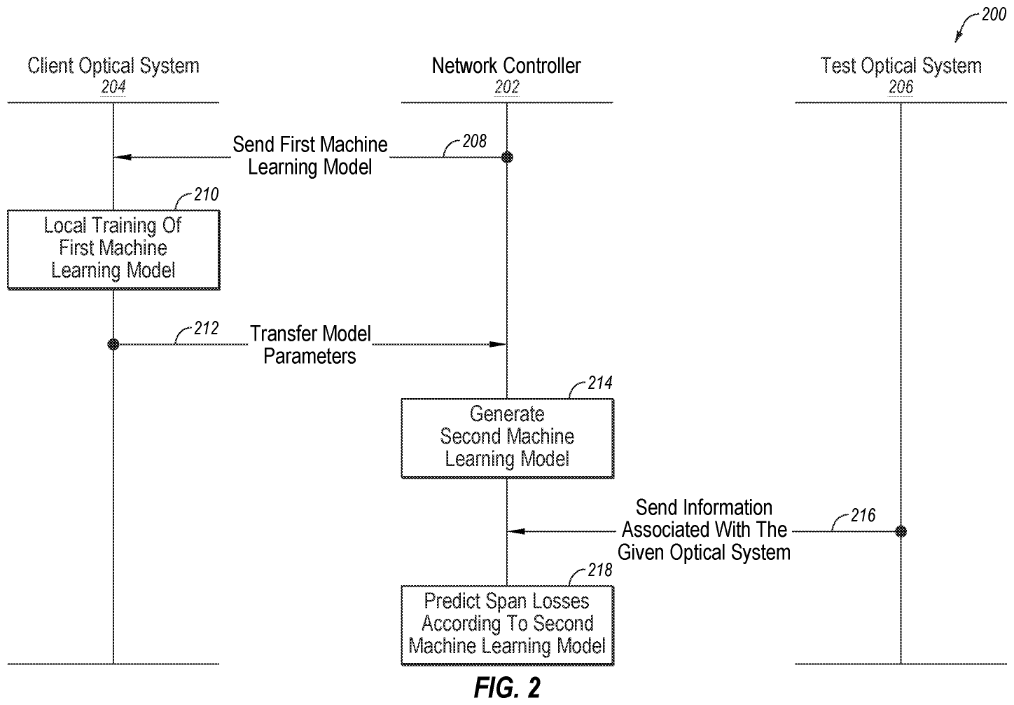

In some embodiments, the network controller 110 may begin a round of federated learning of a machine learning model that is trained to identify span loss. For example, the network controller 110 may send the machine learning model to each of the client optical systems 120 after measuring a predetermined number of span losses and/or after measuring span loss information for a predetermined period of time. During the round of federated learning, each of the client optical systems 120 may locally train the machine learning model based on the respective measured span losses of the client optical systems 120 and send model parameters associated with the locally trained machine learning model back to the network controller 110 such that the network controller 110 may update the machine learning model by aggregating the model parameters of the locally trained machine learning models as described in further detail below. An example of how the federated learning may be performed is given in more detail with respect to FIG. 2.

Modifications, additions, or omissions may be made to the system 100 without departing from the scope of the present disclosure. For example, the designations of different elements in the manner described is meant to help explain concepts described herein and is not limiting. For instance, in some embodiments, the network controller 110 and/or the client optical systems 120 are delineated in the specific manner described to help with explaining concepts described herein but such delineation is not meant to be limiting. Further, the system 100 may include any number of other elements or may be implemented within other systems or contexts than those described.

FIG. 2 is a diagram illustrating example operations 200 related to federated learning and training of the machine learning model for predicting span losses according to at least one embodiment of the present disclosure. The operations 200 may be performed in accordance with at least one embodiment described in the present disclosure. In the illustrated example, the operations 200 may be between a network controller 202, one or more client optical systems 204, and a test optical system 206. In some embodiments, the network controller 202 may be analogous to the network controller 110 of FIG. 1 and the client optical systems 204, and the test optical system 206 may be analogous to the client optical systems 120 of FIG. 1. Additionally or alternatively, the operations 200 may be an example of the operation of the elements of the environment of FIG. 1.

In some embodiments, the operations 200 may be an example of communications and interactions between the network controller 202, the client optical systems 204, and the test optical system 206. Generally, the operations 200 may relate to management of communications between the network controller 202 and the client optical systems 204 to facilitate federated learning of a machine-learning model. The operations 200 illustrated are not exhaustive but are merely representative of operations 200 that may occur. Furthermore, one operation as illustrated may represent one or more communications, operations, and/or data exchanges.

At operations 208, the network controller 202 may send a first machine learning model to the client optical systems 204. In some embodiments, the first machine learning model may be configured to predict the occurrence of span losses in optical systems and may be trained based on span loss data locally collected by each of the client optical systems 204. In these and other embodiments, the first machine learning model may include any machine learning models capable of predicting event occurrences (e.g., via pattern recognition) after being trained based on past event occurrences. For example, the first machine learning model may include a long short-term memory (LSTM) model, a logistic regression model, and/or a naive Bayes model.

In some embodiments, the network controller 202 may send the first machine learning model to a given client optical system 204 during the operations 208 in response to determining that the given client optical system 204 has collected a predetermined amount of span loss data, been in operation for a predetermined period of time, and/or satisfied any other operational criteria indicating that the given client optical system 204 is prepared to participate in a round of federated learning. In some embodiments, the network controller 202 may send a message to each client optical system 204 communicatively coupled to the network controller 202 requesting participation of any client optical systems 204 that have satisfied one or more operational criteria in a round of federated learning. In these and other embodiments, initiation of a given round of federated learning may be based on a time interval (e.g., beginning a round of federated learning every hour, beginning a round of federated learning every three hours after a previous round of federated learning has concluded, etc.). Additionally or alternatively, an operator of the network controller 202 may manually begin the given round of federated learning. After satisfying one or more operational criteria, the given client optical system 204 may signal to the network controller 202 that the given client optical system 204 is available and prepared to participate in a round of federated learning.

In these and other embodiments, the network controller 202 may send the first machine learning model to multiple client optical systems 204. The network controller 202 may send the first machine learning model to each client optical system 204 that has indicated it is available and prepared to participate in a given round of federated learning. Additionally or alternatively, the network controller 202 may determine a number of client optical systems 204 needed for the given round of federated learning and send the first machine learning model to client optical systems 204 until the number of client optical systems 204 needed for the given round of federated learning is satisfied (e.g., on a first-come-first-serve basis).

At operations 210, each of the client optical systems 204 may locally train the first machine learning model based on span loss data collected by each respective client optical system 204. In some embodiments, the local span loss data associated with a given client optical system may be used as training data for the first machine learning model respectively received by the given client optical system, which may result in updates to one or more model parameters of the first machine learning model (e.g., weights in an artificial neural network, coefficient parameters of a logistic regression machine learning model, support vectors of a support vector machine, etc.). As such, the first machine learning model with the locally updated model parameters may be configured to better predict the occurrences of span losses that have previously been experienced by the corresponding client optical system 204. In other words, each client optical system 204 may generate a respective locally trained version of the first machine learning model that is unique based on the span loss information obtained by the corresponding client optical system 204.

At operations 212, the respective model parameters corresponding to the locally trained first machine learning models of each of the client optical systems 204 may be sent to the network controller 202. In some embodiments, the updated model parameters, as determined at operations 210, may be sent to the network controller 202 with or without the locally trained first machine learning model itself. By only transferring the updated model parameters corresponding to each of the locally trained first learning models, less data may be transferred between the network controller 202 and the client optical systems 204, which may improve the speed and/or efficiency at which the network controller 202 may update the first machine learning model based on the locally trained versions of the first machine learning model.

At operations 214, the network controller 202 may generate a second machine learning model based on the locally updated model parameters received from each of the client optical systems. The network controller 202 may aggregate the locally updated model parameters from each of the client optical systems 204 as a single set of model parameters, which may be used as model parameters corresponding to the second machine learning model. In some embodiments, aggregating the locally updated model parameters may include calculating one or more average values of the model parameters. Additionally or alternatively, aggregating the locally updated model parameters may include determining a median, a mode, and/or any other values of the model parameters representative of the locally updated model parameters.

Additionally or alternatively, the network controller 202 may weigh each of the locally updated model parameters during the aggregation process. For example, one or more first locally updated model parameters may correspond to a first given client optical system that includes a large data sample size, and one or more second locally updated model parameters may correspond to a second given client optical system that includes a smaller data sample size. In other words, the first given client optical system may include a large number of measured span losses, while the second given client optical system may include fewer measured span losses than the first given client optical system. In these and other examples, the network controller 202 may weigh each set of model parameters according to the number measured span losses from which each respective set of model parameters were determined (e.g., using a weighted average) to aggregate the first locally updated model parameters and the second locally updated model parameters.

In some embodiments, the second machine learning model may be deployed for a second round of federated learning. For example, the operations 208 through the operations 214 (the “federated learning process”) may be performed iteratively to further update the model parameters associated with the machine learning model and generate a third machine learning model, a fourth machine learning model, etc. Such iterative updating of the model parameters may improve the ability of the machine learning model to predict the occurrences of span losses (e.g., an accuracy of predictions, a breadth of span loss patterns recognized, and/or a speed of predictions).

In these and other embodiments, the federated learning process may be performed iteratively until a predetermined iteration criterion is satisfied. For example, the federated learning process may be performed iteratively using the same and/or new span loss data collected by the client optical systems 204 until the training accuracy of the machine learning model has reached a threshold level, such as a specified root mean square error level. As additional or alternative examples, the federated learning process may be performed iteratively until an iteration criterion relating to a number of training rounds and/or a testing accuracy of the machine learning model is satisfied.

In some embodiments, the trained machine learning model may be applied to other optical systems to perform span loss analysis on the optical systems. For example, information associated with the test optical system 206 may be sent to the network controller 202 at operations 216, and at operations 218, the occurrences of span losses experienced by the test optical system 206 may be determined using the trained machine learning model. Additionally or alternatively, the trained machine learning model may be sent to the test optical system 206 such that the test optical system 206 may locally utilize the trained machine learning model to identify span losses associated with the test optical system 206. In these and other embodiments, the test optical system 206 may include one of the client optical systems 204. The information associated with the test optical system 206 may include the span losses measured from the test optical system 206 over a period of time, which may be analyzed by the trained machine learning model to identify one or more occurrences of span loss in the test optical system 206. In these and other embodiments, the span losses associated with the test optical system 206 predicted by the trained machine learning model may be reviewed by a human user (e.g., operational support staff of the test optical system 206) such that problems with the test optical system 206 may be identified and repaired.

Modifications, additions, or omissions may be made to the operations 200 without departing from the scope of the present disclosure. In these or other embodiments, one or more operations associated with the operations 200 may be omitted or performed by a device other than the network controller 202, the client optical systems 204, and the test optical system 206. Further, the operations 208, 210, 212, 214, 216, and/or 218 may be performed in an ongoing basis such that more than one training rounds for the machine-learning model of the network controller 202 are performed. In addition, one or more operations may be performed by different devices than as described.

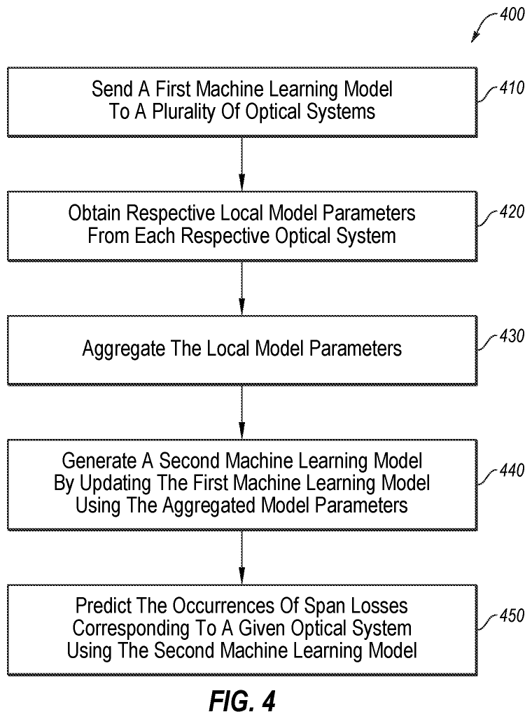

FIG. 4 is a flowchart of an example method 400 of training a machine learning model via federated learning to predict span losses according to at least one embodiment of the present disclosure. The method 400 may be performed by any suitable system, apparatus, or device. For example, the network controller 110 and/or the client optical systems 120 may perform one or more operations associated with the method 400. Although illustrated with discrete blocks, the steps and operations associated with one or more of the blocks of the method 400 may be divided into additional blocks, combined into fewer blocks, or eliminated, depending on the particular implementation.

The method 400 may begin at block 410, where a first machine learning model may be sent to one or more optical systems. For example, a network controller, such as the network controller 110 and/or the network controller 202 as described in FIGS. 1 and 2, respectively, may include the first machine learning model, and the network controller may send the first machine learning model to multiple client optical systems 120 and/or 204 as described in FIGS. 1 and 2, respectively. In some embodiments, the network controller may be prompted to send the first machine learning model in response to receiving information from the client optical systems indicating that the client optical systems have collected a sufficient amount of span loss data to locally train the first machine learning model using the collected span loss data.

In some embodiments, each of the client optical systems may be configured to identify the respective span losses associated with the respective client optical system. After collecting a sufficient amount of span loss data (e.g., a predetermined amount of data as determined by a system operator), a given client optical system may indicate to the network controller that the given client optical system is ready to participate in a given round of federated learning. The given client optical system may receive the first machine learning model from the network controller for the given round of federated learning and locally train the first machine learning model according to the respective identified span losses. In response to the local training of the first machine learning model, one or more model parameters of the first machine learning model for span loss prediction may be updated. The given client optical system may send the locally updated model parameters to the network controller.

At block 420, the network controller may obtain the locally updated model parameters from each of the client optical systems. In some embodiments, the network controller only obtains the locally updated model parameters associated with the machine learning model that the network controller sent to the client optical systems. Additionally or alternatively, the network controller may also obtain the span loss data used to locally train the first machine learning model and/or the locally trained first machine learning model to the network controller from each of the client optical systems.

At block 430, the network controller may aggregate the locally updated model parameters received from all of the client optical systems. In some embodiments, aggregation of the locally updated model parameters may include determining a single set of model parameters associated with the first machine learning model based on all of the locally updated model parameters. In these and other embodiments, the aggregation process may include averaging the locally updated model parameters and/or determining a weighted average of the locally updated model parameters corresponding to the reliability of the respective client optical system from which each set of locally updated model parameters was obtained. For example, a given client optical system that trained the first machine learning model using a large dataset of span loss occurrences may be weighed more heavily than another client optical system that trained the first machine learning model using a small dataset.

At block 440, a second machine learning model may be generated. In some embodiments, the network controller may update the model parameters associated with the first machine learning model sent to the client optical systems using the aggregated model parameters as determined at block 430. As such, the second machine learning model may include code similar to and/or the same as the first machine learning model but with a different set of model parameters. At block 450, the second machine learning model (or the most recently updated version of the machine learning model) may be used to predict the occurrences of span losses corresponding to a given optical system.

In these and other embodiments, the blocks 410 through 440 of the method 400 may be repeated to perform additional rounds of federated learning using the machine learning model generated at block 440. For example, the second machine learning model may be sent to the client optical systems during a second cycle through block 410. The network controller may obtain locally updated model parameters from the client optical systems corresponding to locally trained versions of the second machine learning model during a second cycle through block 420. The network controller may aggregate the locally updated model parameters associated with the second machine learning model during a second cycle through block 430 and generate a third machine learning model by updating the second machine learning model using the aggregated model parameters during a second cycle through block 440. The blocks 410 through 440 may be repeated until one or more iteration criteria are satisfied as described above in relation to FIG. 2.

Modifications, additions, or omissions may be made to the method 400 without departing from the scope of the disclosure. For example, the designations of different elements in the manner described is meant to help explain concepts described herein and is not limiting. Further, the method 400 may include any number of other elements or may be implemented within other systems or contexts than those described.

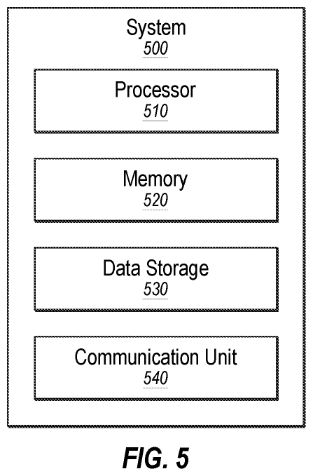

FIG. 5 illustrates an example computing system 500, according to at least one embodiment described in the present disclosure. The computing system 500 may include a processor 510, a memory 520, a data storage 530, and/or a communication unit 540, which all may be communicatively coupled. Any or all of the system 100 of FIG. 1 may be implemented as a computing system consistent with the computing system 500, including the network controller 110 and/or the client optical systems 120.

Generally, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 510 may include any number of processors distributed across any number of network or physical locations that are configured to perform individually or collectively any number of operations described in the present disclosure. In some embodiments, the processor 510 may interpret and/or execute program instructions and/or process data stored in the memory 520, the data storage 530, or the memory 520 and the data storage 530. In some embodiments, the processor 510 may fetch program instructions from the data storage 530 and load the program instructions into the memory 520.

After the program instructions are loaded into the memory 520, the processor 510 may execute the program instructions, such as instructions to cause the system 500 to perform the operations 200 of FIG. 2 and/or the operations of method 400 of FIG. 4. For example, in response to execution of the instructions by the processor 510, the system 500 may transmit machine learning models to the client optical systems, obtain the locally updated model parameters from each of the client optical systems, aggregate the locally updated model parameters, generate updated machine learning models based on the aggregated model parameters, and/or predict the occurrence of span losses corresponding to given optical systems using the updated machine learning models.

The memory 520 and the data storage 530 may include computer-readable storage media or one or more computer-readable storage mediums for having computer-executable instructions or data structures stored thereon. Such computer-readable storage media may be any available media that may be accessed by a general-purpose or special-purpose computer, such as the processor 510. For example, the memory 520 and/or the data storage 530 may store the locally updated model parameters, the aggregated model parameters, and/or span loss data associated with one or more optical systems. In some embodiments, the computing system 500 may or may not include either of the memory 520 and the data storage 530.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

The communication unit 540 may include any component, device, system, or combination thereof that is configured to transmit or receive information over a network. In some embodiments, the communication unit 540 may communicate with other devices at other locations, the same location, or even other components within the same system. For example, the communication unit 540 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 540 may permit data to be exchanged with a network and/or any other devices or systems described in the present disclosure. For example, the communication unit 540 may allow the system 500 to communicate with other systems, such as computing devices and/or other networks.

One skilled in the art, after reviewing this disclosure, may recognize that modifications, additions, or omissions may be made to the system 500 without departing from the scope of the present disclosure. For example, the system 500 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
sending a first machine learning model to a plurality of optical systems in which the first machine learning model is configured to predict span losses in optical systems and in which each respective optical system of the plurality of optical systems is configured to:
identify the span losses associated with the respective optical system; and
locally train the first machine learning model according to the respective identified span losses associated with the respective optical system to obtain a respective local first machine learning model that includes one or more respective local model parameters that predict the respective span losses of the respective optical system;
obtaining the respective local model parameters from each respective optical system without obtaining the corresponding respective locally trained first machine learning model;
generating a second machine learning model by updating the first machine learning model using the obtained local model parameters; and
predicting, by the second machine learning model, occurrences of one or more span losses corresponding to a given optical system.

2. The method of claim 1, further comprising:
sending the second machine learning model to the plurality of optical systems;
obtaining one or more respective second local model parameters from each respective optical system without obtaining the corresponding respective locally trained second machine learning model; and
generating a third machine learning model by updating the second machine learning model using the obtained second local model parameters.

3. The method of claim 2, further comprising:
determining an iteration criterion; and
repeating the steps of claim 2 until the iteration criterion is satisfied.

4. The method of claim 3, wherein the iteration criterion includes at least one of: a number of training rounds, a training accuracy of the machine learning model, or a testing accuracy of the machine learning model.

5. The method of claim 1, wherein the plurality of optical systems includes reconfigurable optical add-drop multiplexer systems (ROADM systems).

6. The method of claim 1, wherein the span losses predicted by the machine learning model include span losses corresponding to at least one of: fiber bending, fiber pinching, or fiber deterioration.

7. The method of claim 1, wherein the machine learning models include at least one of: a long short-term memory model, a logistic regression model, or a naive Bayes model.

8. One or more non-transitory computer-readable storage media configured to store instructions that, in response to being executed, cause a system to perform operations, the operations comprising:
sending a first machine learning model to a plurality of optical systems in which the first machine learning model is configured to predict span losses in optical systems and in which each respective optical system of the plurality of optical systems is configured to:
identify the span losses associated with the respective optical system; and
locally train the first machine learning model according to the respective identified span losses associated with the respective optical system to obtain a respective local first machine learning model that includes one or more respective local model parameters that predict the respective span losses of the respective optical system;
obtaining the respective local model parameters from each respective optical system without obtaining the corresponding respective locally trained first machine learning model;
generating a second machine learning model by updating the first machine learning model using the obtained local model parameters; and
predicting, by the second machine learning model, occurrences of one or more span losses corresponding to a given optical system.

9. The one or more non-transitory computer-readable storage media of claim 8, further comprising:
sending the second machine learning model to the plurality of optical systems;
obtaining one or more respective second local model parameters from each respective optical system without obtaining the corresponding respective locally trained second machine learning model; and
generating a third machine learning model by updating the second machine learning model using the obtained second local model parameters.

10. The one or more non-transitory computer-readable storage media of claim 9, further comprising:
determining an iteration criterion; and
repeating the steps of claim 9 until the iteration criterion is satisfied.

11. The one or more non-transitory computer-readable storage media of claim 10, wherein the iteration criterion includes at least one of: a number of training rounds, a training accuracy of the machine learning model, or a testing accuracy of the machine learning model.

12. The one or more non-transitory computer-readable storage media of claim 8, wherein the plurality of optical systems includes reconfigurable optical add-drop multiplexer systems (ROADM systems).

13. The one or more non-transitory computer-readable storage media of claim 8, wherein the span losses predicted by the machine learning model include span losses corresponding to at least one of: fiber bending, fiber pinching, or fiber deterioration.

14. The one or more non-transitory computer-readable storage media of claim 8, wherein the machine learning models include at least one of: a long short-term memory model, a logistic regression model, or a naive Bayes model.

15. A system comprising:
one or more processors; and
one or more non-transitory computer-readable storage media configured to store instructions that, in response to being executed, cause a system to perform operations, the operations comprising:
sending a first machine learning model to a plurality of optical systems in which the first machine learning model is configured to predict span losses in optical systems and in which each respective optical system of the plurality of optical systems is configured to:
identify the span losses associated with the respective optical system; and
locally train the first machine learning model according to the respective identified span losses associated with the respective optical system to obtain a respective local first machine learning model that includes one or more respective local model parameters that predict the respective span losses of the respective optical system;
obtaining the respective local model parameters from each respective optical system without obtaining the corresponding respective locally trained first machine learning model;
generating a second machine learning model by updating the first machine learning model using the obtained local model parameters; and
predicting, by the second machine learning model, occurrences of one or more span losses corresponding to a given optical system.

16. The system of claim 15, further comprising:
sending the second machine learning model to the plurality of optical systems;
obtaining one or more respective second local model parameters from each respective optical system without obtaining the corresponding respective locally trained second machine learning model; and
generating a third machine learning model by updating the second machine learning model using the obtained second local model parameters.

17. The system of claim 16, further comprising:
determining an iteration criterion; and
repeating the steps of claim 16 until the iteration criterion is satisfied.

18. The system of claim 17, wherein the iteration criterion includes at least one of: a number of training rounds, a training accuracy of the machine learning model, or a testing accuracy of the machine learning model.

19. The system of claim 15, wherein the plurality of optical systems includes reconfigurable optical add-drop multiplexer systems (ROADM systems).

20. The system of claim 15, wherein the span losses predicted by the machine learning model include span losses corresponding to at least one of: fiber bending, fiber pinching, or fiber deterioration.
